(19) United States
(12) Patent Application Publication
(10) Pub. No.: US 2008/0049573 A1
(43) Pub. Date: Feb. 28, 2008

(54) Data recording method and apparatus, recording medium, and data reproducing method and apparatus

(75) Inventors: Toshio Kuroiwa, Kanagawa-ken (JP); Masayoshi Nishitani, Kanagawa-ken (JP); Seiji Higurashi, Tokyo-to (JP)

Correspondence Address: LOUIS WOO;LAW OFFICE OF LOUIS WOO, 717 NORTH FAYETTE STREET, ALEXANDRIA, VA, 22314, US

(73) Assignee: Victor Company of Japan, Ltd., Yokohama (JP)

(21) Appl. No.: 11/822,894

(22) Filed: Jul. 11, 2007

(30) Foreign Application Priority Data
Aug. 24, 2006 (JP) 2006-227652

(51) Int. Cl. G11B 7/00

(52) U.S. Cl. 369/44.39

(57) ABSTRACT

Additional information is generated for each of unit recording blocks in a recording medium. The generated additional information is recorded on a first area in the corresponding unit recording block. A piece of file data is recorded on a second area in each of the unit recording blocks. The second area differs from the first area. The additional information for each of the unit recording blocks includes 1) file identification information for identifying the file data, 2) next-sector address information indicating an address of a unit recording block following the present unit recording block, and 3) first-sector identification information indicating whether or not the present unit recording block is first one of the unit recording blocks assigned to the file data. The additional information may further include effective-data identification information indicating whether a piece of the file data recorded on the present unit recording block is effective or ineffective.

### BACKGROUND OF THE INVENTION

1. Field of the Invention

This invention relates to a method and an apparatus for recording, on a recording medium, file data such as audio visual multimedia contents data and also file system data designed to manage the file data. In addition, this invention relates to a recording medium storing file data and file system data. Furthermore, this invention relates to a method and an apparatus for reproducing file data from such a recording medium.

2. Description of the Related Art

There is an optical recording medium on and from which a signal is recorded and reproduced or erased by an optical drive device. In general, the optical recording medium is used to record and store data handled by a computer or multimedia contents data representing a movie and music pieces.

The operating function of an optical recording medium is separated into three layers, that is, a physical layer, a logical (file system) layer, and an application layer.

The physical layer prescribes the physical properties of the optical recording medium which include the medium shape, the structure of a sector that is a minimum recording unit (a minimum writing unit), and the used modulation method. The physical layer is decided as the physical standards.

The logical (file system) layer is a prescription for enabling data physically recorded on the optical recording medium to be recognized as a file. The logical layer is designed to decide a data (volume) space and a data management structure in units of files, and to provide them to the application layer.

The logical (file system) layer decides a method of using the optical recording medium so that a recording and reproducing apparatus inclusive of a computer can handle data recorded on the medium as files. The logical layer is called the logical standards.

According to the application layer, a data structure for allowing the utilization of audio visual contents and applications such as programs is decided as the application standards.

The recording and reproduction of data on and from an optical recording medium are performed on a sector-by-sector basis, where “sector” means a recording block. An address (address information) is given to every sector in the optical recording medium. A recording and reproducing apparatus reads sector addresses from the optical recording medium, and finds target sectors in response to the read addresses. The target sectors mean sectors on which data should be recorded or from which data should be reproduced.

Minimum writing units in the recording of data on an optical recording medium are sectors. Data related to one lump such as one content is divided into pieces recorded on respective sectors which are studded over a recording area of an optical recording medium. Thus, the one-lump data corresponds to a group of sectors studded over the recording area.

In the absence of attribute information representing the type, size, and other factors of one-lump data (for example, one-content data) recorded on an optical recording medium, a recording and reproducing apparatus can not recognize which of on-medium sectors store the pieces of the one-lump data respectively. Thus, in this case, the apparatus can not handle the one-lump data as a file.

A file system defined by the above-mentioned logical layer is designed so as to allow a recording and reproducing apparatus to handle one-lump data recorded on sectors in an optical recording medium as a file.

The whole recording area in an optical recording medium is called a data (volume) space. The file system decides not only the structure of the data space but also a file structure. The file system manages the recording area, files, and directories. Data forming a file, that is, file data, is recorded on the recording area in the optical recording medium. Generally, the optical recording medium has a lead-in area and a lead-out area between which the recording area extends. The recording area includes a system data area in the vicinity or immediate vicinity of the lead-in area or the lead-out area of the medium. Data representing the file system, that is, file system data, is recorded on the system data area.

To reproduce file data from an optical recording medium, a recording and reproducing apparatus finds file system data in the recording area of the medium, and then reads out, from the file system data, information representing the file structure of the to-be-reproduced file data. The file structure information indicates the addresses and order numbers of sectors storing the file data. The file structure information contains attribute information representing the type, size, and other factors of the file data. The apparatus detects the attribute information and the addresses and order numbers of target sectors from the file structure information. The apparatus reads sector addresses from the data recording area in the optical recording medium, and detects every read sector address equal to one of the target sector addresses. Thereby, the apparatus identifies the target sectors on the medium. The apparatus accesses the target sectors on the medium in the sequence accorded with the target-sector order numbers, and reads out the pieces of the file data therefrom.

Japanese patent number 2928169 discloses a method of managing discontinuously-distributed data areas in a disc. The method has a step of providing a file area management table at the head of the first one of the data areas. The file area management table stores information for managing a prescribed number of data areas selected among all the data areas. The selected data areas are the above-indicated first data area and later data areas. The selected data areas are assigned to a common file. The file area management table has a sequence of a table header, area information blocks assigned to the selected data areas respectively, and an ending segment to be loaded with a start pointer for a data area immediately following the last one of the selected data areas in specified conditions. The area information block assigned to the first data area has a flag indicating whether or not the first data area is used, a start pointer for a part of the first data area which is unoccupied by the file area management table, an end pointer for the first data area, and an end pointer for data in the first data area. Each of the other area information blocks has a flag indicating whether or not the related data area is used, a start pointer for the related data area, an end pointer for the related data area, and an end pointer for data in the related data area.

In the case where the selected data areas managed by the file area management table (the first file area management table) are insufficient to accommodate the file, the method in Japanese patent number 2928169 provides a second file area management table at the head of the data area immediately following the last one of the selected data areas. Furthermore, the method provides the end of the first file area management table with a start pointer for the data area immediately following the last one of the selected data areas. The second file area management table is similar in structure to the first file area management table. The second file area management table is designed to manage the prescribed number of data areas starting from the data area immediately following the last one of the selected data areas. Therefore, it is possible to define a file in which discontinuously-distributed data areas in a disc are chained.

Standard JIS X 0605 (equivalent to International Standard ISO/IEC 9293) for information technology prescribes the volume and file structure of disk cartridges for information interchange.

File system data is locally recorded on an optical recording medium. In the event that the reading of the file system data from the medium is impossible, the attribute information about file data and the on-medium position thereof are undetectable so that the file data can not be read from the medium.

In the case where additional file data is recorded on a region in an optical recording medium which immediately follows the end of already-recorded file data to update a related file into a greater file, or in the case where an intermediate portion is deleted from file data recorded on an optical recording medium, the recalculation of an error correction code is required for each recording block. Thus, in this case, file data and other data are read from each pertinent recording block on the medium, and an error correction code is recalculated on the basis of the read file data and other data before the recalculated error correction code is recorded back on the recording block as updated file data. These steps tend to lower the reliability of the updated file data recorded on the medium.

### SUMMARY OF THE INVENTION

It is an object of this invention to provide a recording method, a recording apparatus, a recording medium, a reproducing method, and a reproducing apparatus which enable a file to be restored in the event that file system data locally recorded on a recording medium has been lost.

It is another object of this invention to provide a recording method, a recording apparatus, a recording medium, a reproducing method, and a reproducing apparatus which allow the recording of additional file data and the deletion of an intermediate portion from recorded file data without lowering the reliability of updated file data.

A first aspect of this invention provides a method of recording file data on a recording medium. The method comprises the steps of generating additional information for each of unit recording blocks in the recording medium; recording the generated additional information on a first area in the corresponding unit recording block; and recording a piece of the file data on a second area in each of the unit recording blocks, the second area differing from the first area. The generated additional information for each of the unit recording blocks includes 1) file identification information for identifying the file data, 2) next-sector address information indicating an address of a unit recording block which follows the present unit recording block, and 3) first-sector identification information indicating whether or not the present unit recording block is first one of the unit recording blocks assigned to the file data.

A second aspect of this invention is based on the first aspect thereof, and provides a method further comprising the step of recording file system data for management of the file data on a system data recording area in the recording medium, the system data recording area being unoccupied by the recorded additional information and the recorded file data.

A third aspect of this invention is based on the first aspect thereof, and provides a method wherein the generated additional information for each of the unit recording blocks further includes effective-data identification information indicating whether a piece of the file data which is recorded on the present unit recording block is effective or ineffective.

A fourth aspect of this invention provides an apparatus for recording file data on a recording medium. The apparatus comprises means for generating additional information for each of unit recording blocks in the recording medium; means for recording the generated additional information on a first area in the corresponding unit recording block; and means for recording a piece of the file data on a second area in each of the unit recording blocks, the second area differing from the first area. The generated additional information for each of the unit recording blocks includes 1) file identification information for identifying the file data, 2) next-sector address information indicating an address of a unit recording block which follows the present unit recording block, and 3) first-sector identification information indicating whether or not the present unit recording block is first one of the unit recording blocks assigned to the file data.

A fifth aspect of this invention is based on the fourth aspect thereof, and provides an apparatus further comprising means for recording file system data for management of the file data on a system data recording area in the recording medium, the system data recording area being unoccupied by the recorded additional information and the recorded file data.

A sixth aspect of this invention is based on the fourth aspect thereof, and provides an apparatus wherein the generated additional information for each of the unit recording blocks further includes effective-data identification information indicating whether a piece of the file data which is recorded on the present unit recording block is effective or ineffective.

A seventh aspect of this invention provides a recording medium comprising unit recording blocks each having a first area storing additional information and a second area storing a piece of file data, the first area and the second area differing from each other. The additional information stored in the first area in each of the unit recording blocks includes 1) file identification information for identifying the file data, 2) next-sector address information indicating an address of a unit recording block which follows the present unit recording block, and 3) first-sector identification information indicating whether or not the present unit recording block is first one of the unit recording blocks assigned to the file data.

An eighth aspect of this invention is based on the seventh aspect thereof, and provides a recording medium further comprising a system data recording area storing file system data for management of the file data, the system data recording area being unoccupied by the recorded additional information and the recorded file data.

A ninth aspect of this invention is based on the seventh aspect thereof, and provides a recording medium wherein the additional information stored in the first area in each of the unit recording blocks further includes effective-data identification information indicating whether a piece of the file data which is recorded on the present unit recording block is effective or ineffective.

A tenth aspect of this invention provides a method of reproducing file data from a recording medium comprising unit recording blocks each having a first area storing additional information and a second area storing a piece of file data, the first area and the second area differing from each other. The additional information stored in the first area in each of the unit recording blocks includes 1) file identification information for identifying the file data, 2) next-sector address information indicating an address of a unit recording block which follows the present unit recording block, and 3) first-sector identification information indicating whether or not the present unit recording block is first one of the unit recording blocks assigned to the file data. The recording medium further comprises a system data recording area storing file system data for management of the file data, the system data recording area being unoccupied by the recorded additional information and the recorded file data. The method comprises the steps of reading the file system data from the recording medium; deciding whether or not the reading of the file system data from the recording medium is successful; reading the file identification information, the next-sector address information, and the first-sector identification information from each of the unit recording blocks in the recording medium when it is decided that the reading of the file system data from the recording medium is not successful; generating file management data from the read file identification information, the read next-sector address information, and the read first-sector identification information; and reading the file data from the recording medium in response to the generated file management data.

An eleventh aspect of this invention provides an apparatus for reproducing file data from a recording medium comprising unit recording blocks each having a first area storing additional information and a second area storing a piece of file data, the first area and the second area differing from each other. The additional information stored in the first area in each of the unit recording blocks includes 1) file identification information for identifying the file data, 2) next-sector address information indicating an address of a unit recording block which follows the present unit recording block, and 3) first-sector identification information indicating whether or not the present unit recording block is first one of the unit recording blocks assigned to the file data. The recording medium further comprises a system data recording area storing file system data for management of the file data, the system data recording area being unoccupied by the recorded additional information and the recorded file data. The apparatus comprises means for reading the file system data from the recording medium; means for deciding whether or not the reading of the file system data from the recording medium is successful; means for reading the file identification information, the next-sector address information, and the first-sector identification information from each of the unit recording blocks in the recording medium when it is decided that the reading of the file system data from the recording medium is not successful; means for generating file management data from the read file identification information, the read next-sector address information, and the read first-sector identification information; and means for reading the file data from the recording medium in response to the generated file management data.

### BRIEF DESCRIPTION OF THE DRAWINGS

FIG. 1 is a block diagram of an apparatus for recording and reproducing data on and from an optical disc according to a first embodiment of this invention.

FIG. 2 is a diagram showing an example of the structure of one sector data block generated by the apparatus of FIG. 1.

FIG. 3 is a diagram of successive sectors on an optical disc, the absolute physical addresses of the sectors, and a first example of the states of file identification information, next-sector address information, first-sector identification information, and effective-data identification information recorded on each of the sectors.

FIG. 4 is a plan view of an optical disc in FIG. 1.

FIG. 5 is a diagram showing an example of file management data stored in a memory within a host in FIG. 1.

FIG. 6 is a diagram of the successive sectors, the absolute physical addresses of the sectors, and a second example of the states of the file identification information, the next-sector address information, the first-sector identification information, and the effective-data identification information recorded on each of the sectors.

FIG. 7 is a diagram of the successive sectors, the absolute physical addresses of the sectors, and a third example of the states of the file identification information, the next-sector address information, the first-sector identification information, and the effective-data identification information recorded on each of the sectors.

FIG. 8 is a diagram showing an example of file management data in a second embodiment of this invention.

### DETAILED DESCRIPTION OF THE INVENTION

### First Embodiment

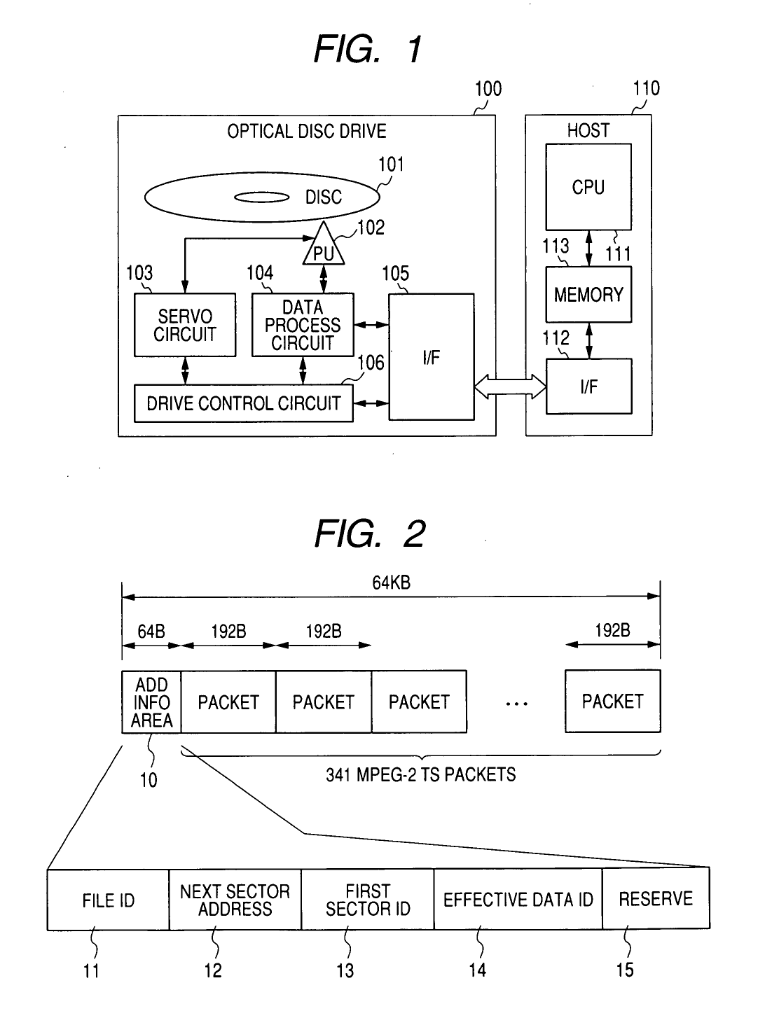

FIG. 1 shows an apparatus for recording and reproducing data on and from an optical disc according to a first embodiment of this invention. The apparatus of FIG. 1 includes an optical disc drive 100 and a host 110.

The optical disc drive 100 records and reproduces data or information on and from a recording medium or an optical disc 101. The data represents, for example, audio visual contents. The optical disc drive 100 includes an optical pickup 102, a servo circuit 103, a data processing circuit 104, an interface (I/F) 105, and a drive control circuit 106.

During the recording mode of operation of the optical disc drive 100, the data processing circuit 104 receives data from the interface 105 and processes the received data. The data processing circuit 104 feeds the resultant processed data to the optical pickup 102. The optical pickup 102 generates a recording laser beam which carries the processed data. The optical pickup 102 applies the recording laser beam to the optical disc 101. The recording laser beam scans the optical disc 101 while a spindle motor (not shown) rotates the optical disc 101. As a result, the processed data is recorded on the optical disc 101. The position of the optical pickup 102 relative to the optical disc 101 is controlled by the servo circuit 103. The drive control circuit 106 communicates with the servo circuit 103, the data processing circuit 104, and the interface 105.

During the reproducing mode of operation of the optical disc drive 100, the optical pickup 102 generates a reading laser beam. The optical pickup 102 applies the reading laser beam to the optical disc 101. The reading laser beam scans the optical disc 101 while the spindle motor (not shown) rotates the optical disc 101. The reading laser beam is reflected by the optical disc 101 before returning to the optical pickup 102. The return laser beam contains read data equal to data recorded on the optical disc 101. The optical pickup 102 extracts the read data from the return laser beam. The optical pickup 102 feeds the read data to the data processing circuit 104. The data processing circuit 104 processes the read data. The data processing circuit 104 feeds the resultant processed data to the interface 105. The position of the optical pickup 102 relative to the optical disc 101 is controlled by the servo circuit 103. The drive control circuit 106 communicates with the servo circuit 103, the data processing circuit 104, and the interface 105.

The host 110 includes a combination of a CPU 111, an interface 112, and a memory 113. The CPU 111 operates in accordance with a control program (a computer program) stored in an internal memory or an external memory not shown. The control program enables the CPU 111 to function as an additional-information generating means, a recording means, a system-data reading means, a file-management-data generating means, and a file-data reading means. The interface 112 is connected with the interface 105 within the optical disc drive 100. The interfaces 105 and 112 cooperate to transfer data and control signals between the host 110 and the optical disc drive 100. The memory 113 stores the absolute physical address of the first sector among sectors assigned to one file or each file.

The apparatus of FIG. 1 records file data on the optical disc 101 on a recording-block by recording-block basis, where “recording block” is a recording unit corresponding to one sector on the optical disc 101. The apparatus generates data blocks for respective on-disc sectors from the to-be-recorded file data. These data blocks are called the sector data blocks.

FIG. 2 shows an example of the structure of one sector data block recorded on one on-disc sector. With reference to FIG. 2, the size of one sector is equal to about 64 KB (65536 bytes). File data to be recorded on the optical disc 101 has a stream of TS packets conforming to the MPEG standards. Every TS packet consists of a 4-byte header for managing the timing of the packet, and a 188-byte main portion following the header. Thus, every TS packet has a size of 192 bytes. Accordingly, 341 TS packets can be placed in one 64-KB sector. For example, 64 bytes at the head of every sector are used as an additional-information recording area 10. The remaining part of every sector is loaded with a sequence of 341 TS packets.

The apparatus of FIG. 1 records file identification information (file ID) 11, next-sector address information 12, first-sector identification information 13, and effective-data identification information 14 on the additional-information recording area 10 in every sector as pieces of additional information respectively.

The file identification information 11 is identification information of a file to which a file data piece recorded in the related sector belongs. The file identification information 11 allows discrimination between file data belonging to one file and file data belonging to another file. The next-sector address information 12 is next-recording-block address information. The next-sector address information 12 denotes the address of a sector following the present sector regarding one file. The first-sector identification information 13 indicates whether or not the related sector is the first sector among sectors assigned to file data belonging to one file. The effective-data identification information 14 indicates whether or not a file data piece recorded on the related sector is effective.

As shown in FIG. 2, the file identification information 11, the next-sector address information 12, the first-sector identification information 13, and the effective-data identification information 14 are arranged in that order within the additional-information recording area 10. It should be noted that the file identification information 11, the next-sector address information 12, the first-sector identification information 13, and the effective-data identification information 14 may be arranged in an order different from that in FIG. 2. The next-sector address information 12, the first-sector identification information 13, or the effective-data identification information 14 may occupy the front end of the additional-information recording area 10.

There is reserve information (a reserve area) 15 in the rear end of the additional-information recording area 10. In FIG. 2, the reserve information 15 follows the effective-data identification information 14. The reserve information 15 may have stuffing bits for properly sizing the additional-information recording area 10. Alternatively, the reserved information 15 may have a last-sector identifier (last-sector identification information) which indicates whether or not the related sector is the last sector among sectors assigned to file data belonging to one file.

File data belonging to one file is divided into pieces recorded on respective sectors in the optical disc 101. The file identification information 11 is varied from file to file so that a decision can be made about which of files a file data piece recorded on every sector belongs to. Preferably, the file identification information 11 may include information peculiar to the related file which represents, for example, the time of the start of recording the corresponding file data or the name of the related file. File name information or file attribute information defined by a file system for the management of file recording may be used as the file identification information 11. In this case, file management linked with the file system can easily be implemented.

The next-sector address information 12 includes the absolute physical address of a sector following the present sector which is measured from the head of the optical disc 101. The present sector and the sector following the present sector concern a common file. It should be noted that the next-sector address information 12 may include a relative physical address indicating a distance to a sector following the present sector in terms of sector number.

There is a sector on which the last one of pieces of file data belonging to one file is recorded. It is unnecessary for such an in-file last sector to denote the physical address of a next sector. Accordingly, end information formed by a signal of “0” is recorded on the additional-information recording area 10 in the in-file last sector as the next-sector address information 12. The end information indicates that the related sector contains the last one of pieces of file data belonging to one file.

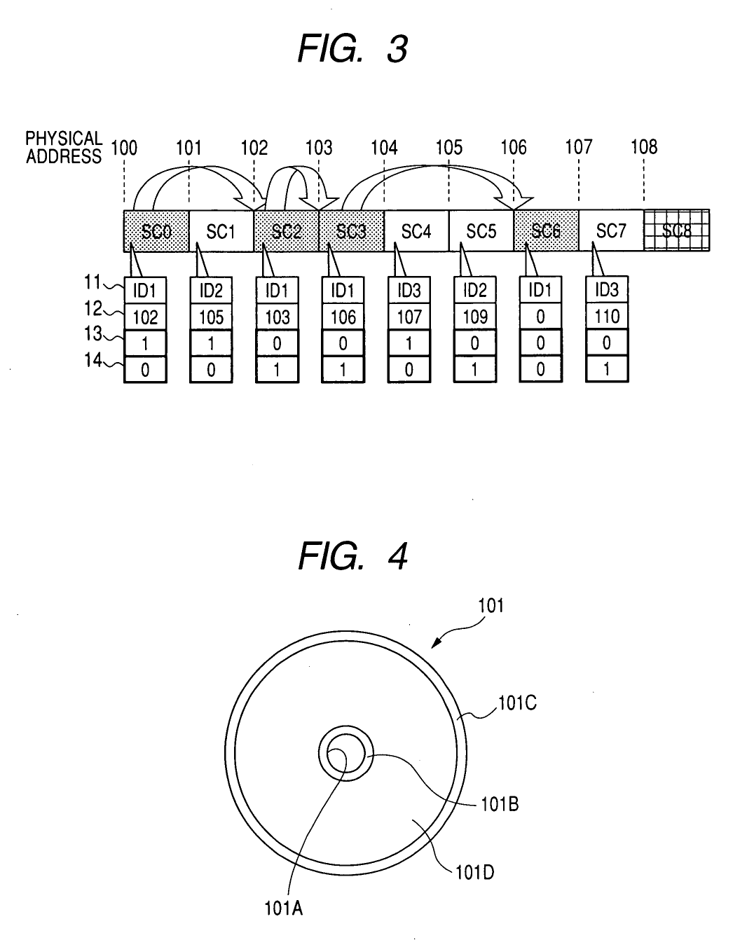

FIG. 3 shows an example of the setting of the file identification information 11, the next-sector address information 12, the first-sector identification information 13, and the effective-data identification information 14 recorded on each sector on the optical disc 101.

Serial numbers or numerals in an upper portion of FIG. 3 denote the absolute physical addresses of successive sectors SC0, SC1, SC2, SC3, . . . which are measured from the head of the optical disc 101. The additional information including the file identification information 11, the next-sector address information 12, the first-sector identification information 13, and the effective-data identification information 14 is recorded on the additional-information recording area 10 in the head of each sector. The file identification information 11 represents a file identification number IDi (ID1, ID2, ID3, . . . ) which is varied from file to file.

The first-sector identification information 13 being “1” indicates that the related sector is the first one of sectors assigned to one file. The first-sector identification information 13 being “0” indicates that the related sector differs from the first one of sectors assigned to one file.

The effective-data identification information 14 being “1” indicates that the file data piece in the related sector is effective. The effective-data identification information 14 being “0” indicates that the file data piece in the related sector is ineffective.

As shown in FIG. 4, the optical disc 101 has a central opening 101A. The optical disc 101 has a lead-in area 101B and a lead-out area 101C at its innermost part and outermost part respectively. In addition, the optical disc 101 has a recording area 101D for storing file data. The recording area 101D extends between the lead-in area 101B and the lead-out area 101C. The apparatus of FIG. 1 generates file system data for managing file data recorded on the optical disc 101. The apparatus records the file system data on a portion of the recording area 101D which extends in the vicinity or immediate vicinity of the lead-in area 101B or the lead-out area 101C.

Without reading file system data from the optical disc 101, the apparatus of FIG. 1 can recognize the structure of file data corresponding to the file identification information 11 being ID1 (see FIG. 3) as follows. The apparatus sequentially accesses sectors from the head of the optical disc 101 until meeting or finding the first sector having the additional information in which the file identification information 11 is ID1 and the first-sector identification information 13 is “1”. The apparatus reads the additional information from the additional-information recording area 10 in each accessed sector. The apparatus decides whether or not the file identification information 11 in the read additional information is ID1 and the first-sector identification information 13 therein is “1”. Thereby, the apparatus finds the above-indicated first sector. In FIG. 3, the sector SC0 is the first sector for the file data corresponding to the file identification information 11 being ID1.

Then, the apparatus decides whether or not the next-sector address information 12 in the read additional information is “0”. When the next-sector address information 12 is not “0”, the apparatus detects the absolute physical address of the second sector, which stores a piece of the file data corresponding to the file identification information 11 being ID1, from the next-sector address information 12. Subsequently, the apparatus accesses the second sector in response to the detected address thereof. Similarly, the apparatus sequentially accesses the third and later sectors, which store pieces of the file data corresponding to the file identification information 11 being ID1, until meeting or finding the sector (the in-file last sector) having the additional information in which the next-sector address information 12 is “0”. The next-sector address information 12 being “0” indicates that the present sector is the last sector among all the sectors storing the file data corresponding to the file identification information 11 being ID1. Accordingly, the apparatus recognizes the structure of the file data corresponding to the file identification information 11 being ID1.

In FIG. 3, regarding the file data corresponding to the file identification information 11 being ID1, a sequence of the sectors successively accessed by the apparatus of FIG. 1 starts from the sector SC0 located at an absolute physical address of “100” and having the additional information in which the file identification information 11 is ID1 and the first-sector identification information 13 is “1”. A one-stage portion of the sequence of the sectors is determined by the absolute physical address denoted by the next-sector address information 12 in the additional information in each of the sectors. In FIG. 3, regarding the file data corresponding to the file identification information 11 being ID1, the sectors are successively accessed in an order as SC0→SC2→SC3→SC6 while the next-sector address information 12 in the additional information in each of the sectors is referred to. The sequence of the sectors ends at the sector SC6 located at an absolute physical address of “106” since the sector SC6 has the additional information in which the next-sector address information 12 is “0”. In this way, the apparatus detects that the file data corresponding to the file identification information 11 being ID1 consists of pieces stored in the sectors SC0, SC2, SC3, and SC6 respectively.

In FIG. 3, the effective-data identification information 14 in the additional information in each of the first and last sectors SC0 and SC6 is “0”, and hence indicates that an effective file data piece is recorded on neither the first sector SC0 nor the last sector SC6. Accordingly, the file data pieces recorded on the sectors SC2 and SC3 form a corresponding complete file.

During the recording of file data belonging to one file on the optical disc 101, the apparatus of FIG. 1 records ineffective file data such as stuffing data on the file-data recording areas of the first and last sectors among target sectors assigned to the file. Therefore, effective file data is absent from the first and last sectors. The absence of the effective file data from the first and last sectors results in the sure reproduction of the effective file data from the optical disc 101.

In FIG. 3, the sector SC8 is in an unused state. Thus, an absolute physical address of “108” which corresponds to the sector SC8 is not referred to by the additional information in any of the other sectors.

The fixed bit length of one sector is divided by the fixed bit length of one packet (one TS packet). A front end of the sector which is equal in size to the remainder in the division is used as the additional-information recording area 10. The rest of the sector is divided into segments assigned to packets respectively. Sectors and packets may be designed so that the fixed bit length of one sector may be exactly divisible by the fixed bit length of one packet. In this case, one sector is divided into segments assigned to packets respectively, and the first one of the segments is used as the additional-information recording area 10.

The apparatus of FIG. 1 operates in a mode changeable among different modes including a file-data recording mode, a file-data reproducing mode using file system data, a file-data reproducing mode using additional information, a file-data additionally-recording mode, and an intermediate-file-data deleting mode. The control program for the CPU 111 is designed to implement operation steps indicated hereafter.

The file-data recording mode of operation of the apparatus of FIG. 1 is performed in the case where file data (real data) representing information or contents and belonging to one file is fed from the host 110 to the optical disc drive 100 and is recorded on the optical disc 101. During the file-data recording mode of operation, the CPU 111 within the host 110 decides whether or not recorded file system data is present in the optical disc 101. To this end, the CPU 111 may control the optical disc drive 100 to search the optical disc 101 for file system data. When recorded file system data is present, the CPU 111 controls the optical disc drive 100 to read the file system data from the optical disc 101. The CPU 111 receives the read file system data from the optical disc drive 100. The CPU 111 detects a sector arrangement (a sector layout) in the recording area of the optical disc 101 from the received file system data. The CPU 111 computes the total number of sectors, which are required for the recording of file data (real data), from the size of the file data to be recorded. By referring to the detected sector arrangement, the CPU 111 selects ones among all the sectors in the recording area of the optical disc 101 as sectors to be used to store the file data. The CPU 111 derives the absolute physical addresses of the to-be-used sectors from the detected sector arrangement. The CPU 111 virtually arranges the to-be-used sectors in a sequence, and generates file identification information 11, next-sector address information 12, first-sector identification information 13, effective-data identification information 14, and reserve information 15 for each of the to-be-used sectors.

The CPU 111 writes, into the memory 113, the to-be-recorded file data (the to-be-recorded real data), a signal representing the total number of sectors required for the recording of the file data, a signal representing the absolute physical addresses of the to-be-used sectors, and identification information. The absolute physical addresses of the to-be-used sectors will be the recording start positions therein. In addition, the CPU 111 writes, into the memory 113, the file identification information 11, the next-sector address information 12, the first-sector identification information 13, the effective-data identification information 14, and the reserve information 15 for each of the to-be-used sectors. The file identification information 11 enables the file data recorded on the optical disc 102 to be managed as a file, and allows the discrimination between file data belonging to one file and file data belonging to another file.

The CPU 111 controls the memory 113 to serve as a multiplexer for multiplexing the to-be-recorded file data, the file identification information 11, the next-sector address information 12, the first-sector identification information 13, the effective-data identification information 14, and the reserve information 15 into a sequence of sector data blocks (data blocks assigned to on-disc sectors respectively), and for outputting the sequence of sector data blocks to the interface 112. Each of the sector data blocks has the same structure as that in FIG. 2. The file identification information 11, the next-sector address information 12, the first-sector identification information 13, the effective-data identification information 14, and the reserve information 15 are placed in the head of each sector data block. A piece of the to-be-recorded file data is placed in the post-head portion of each sector data block.

As previously mentioned, the file identification information 11, the next-sector address information 12, the first-sector identification information 13, the effective-data identification information 14, and the reserve information 15 are recorded on the additional-information recording area 10 of each sector on the optical disc 101. The file identification information 11 is varied from file to file. Therefore, by referring to the file identification information 11 in each sector on the optical disc 101, file data pieces constituting one file and recorded on different sectors can be judged to be in the same file. Preferably, the file identification information 11 may include information peculiar to the related file which represents, for example, the time of the start of recording the corresponding file data or the name of the related file. File name information or file attribute information defined by a file system for the management of file recording may be used as the file identification information 11. In this case, file management linked with the file system can easily be implemented.

The next-sector address information 12 includes the absolute physical address of a sector following the present sector which is measured from the head of the optical disc 101. The present sector and the sector following the present sector concern a common file. It should be noted that the next-sector address information 12 may include a relative physical address indicating a distance to a sector following the present sector in terms of sector number. For example, the next-sector address information 12 in the first sector among sectors concerning one file includes the absolute physical address of the first sector while the next-sector address information 12 in each of the second and later sectors includes a relative physical address indicating a distance to a sector following the present sector. There is a sector on which the last one of pieces of file data belonging to one file is recorded. End information formed by a signal of “0” is recorded on the in-file last sector as the next-sector address information 12.

The first-sector identification information 13 is “1” when the related sector is the first one of sectors assigned to one file. Otherwise, the first-sector identification information 13 is “0”. During file retrieval, the first-sector identification information 13 being “1” is a mark used to find the first sector among sectors assigned to a desired file.

The effective-data identification information 14 is “1” when the file data piece in the related sector is effective. The effective-data identification information 14 is “0” when the file data piece in the related sector is ineffective. The file-data recording area in a sector having the effective-data identification information 14 being “0” is filled with arbitrary data (non-file data) or stuffing data. The effective-data identification information 14 for the first and last sectors among sectors assigned to one file is “0”, and effective file data pieces are not placed in the first and last sectors.

As previously mentioned, the memory 113 outputs a sequence of sector data blocks to the interface 112 while being controlled by the CPU 111. When the memory 113 outputs the sector data block for the last sector among the to-be-used sectors, outputting the sequence of sector data blocks to the interface 112 is completed for the file data to be recorded. The interface 112 sends the sequence of sector data blocks to the interface 105 within the optical disc drive 100. In the presence of other file data to be recorded, a sequence of sector data blocks is generated and is outputted to the interface 112 similarly before being sent from the interface 112 to the interface 105 within the optical disc drive 100.

The host 110 generates file system data defined by a file system and corresponding to the present file data, and outputs the generated file system data to the optical disc drive 100. The generation of the file system data is in a conventional way. Specifically, the CPU 111 controls the memory 113 to compose file system data from identification information, the signal representing the total number of sectors required for the recording of the file data, and the signal representing the recording start positions in the to-be-used sectors (the absolute physical addresses of the to-be-used sectors). The foregoing identification information is similar to the file identification information 11, and represents, for example, the name of the related file. In addition, the CPU 111 controls the memory 113 to send the composed file system data to the interface 112. The file system data is outputted from the interface 112 to the interface 105 within the optical disc drive 100. The optical disc drive 100 records the file system data on a prescribed portion of the recording area 101D of the optical disc 101 in a conventional way. The prescribed portion extends in the vicinity or immediate vicinity of the lead-in area 101B or the lead-out area 101C of the optical disc 101 (see FIG. 4).

In the optical disc drive 100, the interface 105 feeds the sequence of sector data blocks to the data processing circuit 104. The data processing circuit 104 subjects the sequence of sector data blocks to encoding for error correction and modulation for recording to get processed data. The data processing circuit 104 feeds the processed data to the optical pickup 102. The optical pickup 102 records the processed data on the to-be-used sectors in the optical disc 101. The recording of the processed data is on a sector-by-sector basis. The file identification information 11, the next-sector address information 12, the first-sector identification information 13, the effective-data identification information 14 which constitute the additional information are recorded on the additional-information recording area 10 of each of the to-be-used sectors. The file data (the real data) is recorded on the to-be-used sectors except the additional-information recording areas 10.

The file-data reproducing mode of operation of the apparatus of FIG. 1 which uses the file system data is as follows. When file data representing information or contents and belonging to one file is required to be reproduced from the optical disc 101, the host 110 generates a related command and outputs the generated command to the optical disc drive 100. The command propagates from the interface 112 within the host 110 to the interface 105 within the optical disc drive 100. In the optical disc drive 100, the command travels from the interface 105 to the drive control circuit 106. The drive control circuit 106 controls the servo circuit 103 in accordance with the command, thereby moving the optical pickup 102 to a position for accessing a portion of the recording area 101D of the optical disc 101 which is assigned to file system data. The optical pickup 102 searches this portion of the recording area 101D for file system data corresponding to the desired file data, and reads the file system data from the optical disc 101. The read file system data travels from the optical pickup 102 to the interface 105 through the data processing circuit 104. The file system data is sent from the interface 105 to the interface 112 within the host 110 before being stored into the memory 113. The CPU 111 in the host 110 refers to the file system data in the memory 113. The file system data describes the positions of on-disc sectors (target sectors) storing pieces of the desired file data. The CPU 111 detects the positions of the target sectors from the file system data. The CPU 111 sends information (positional information) about the positions of the target sectors to the drive control circuit 106 within the optical disc drive 100 via the memory 113, the interface 112, and the interface 105. The drive control circuit 106 controls the servo circuit 103 in response to the positional information so that the optical pickup 102 will sequentially access the target sectors and read data pieces therefrom.

The optical pickup 102 feeds the read data to the data processing circuit 104. The data processing circuit 104 subjects the read data to demodulation for reproduction and decoding for error correction to get processed data. The data processing circuit 104 feeds the processed data to the interface 105. The interface 105 sends the processed data to the interface 112 within the host 110. The interface 112 writes the incoming data into the memory 113. The data traveling from the interface 112 to the memory 113 is in the form of a sequence of sector data blocks. The CPU 111 controls the memory 113 to serve as a demultiplexer for separating the desired file data from the written data (the sequence of sector data blocks) and outputting the desired file data. The CPU 111 or another device receives the desired file data from the memory 113. In this way, the desired filed data is reproduced.

The file-data reproducing mode of operation of the apparatus of FIG. 1 which uses the additional information is as follows. The present file-data reproducing mode of operation is performed in the event of failure in the reading of file system data from the optical disc 101. Such failure is caused by, for example, a scratch on or a flaw in the optical disc 101. The present file-data reproducing mode of operation enables on-disc sectors (target sectors) storing pieces of the desired file data to be detected even in the case where file system data can not be read from the optical disc 101. For example, the CPU 111 in the host 110 decides whether or not file system data is successfully read from the optical disc 101 by the optical pickup 102 on the basis of first and second information pieces. The first information piece indicates whether or not an on-disc sector currently-accessed by the optical disc 102 is one assigned to file system data. The CPU 111 has the first information piece therein. The second information piece relates to a malfunction signal fed to the drive control circuit 106. The CPU 111 communicates with the drive control circuit 106 via the memory 11, interface 112, and the interface 105 to get the second information piece. A first example of the malfunction signal is a signal fed from the servo circuit 103 to the drive control circuit 106 and indicating that tracking is wrong. A second example of the malfunction signal is a signal fed from the data processing circuit 104 to the drive control circuit 106 and indicating that data error correction is wrong. In the event that the malfunction signal is fed to the drive control circuit 106 while the first information piece indicates that an on-disc sector currently-accessed by the optical disc 102 is one assigned to file system data, the CPU 111 decides that the file system data is not successfully read from the optical disc 101 by the optical pickup 102. Otherwise, the CPU 111 decides that the file system data is successfully read from the optical disc 101 by the optical pickup 102. When file system data is not successfully read, the CPU 111 starts the file-data reproducing mode of operation of the apparatus of FIG. 1 which uses the additional information.

During a former stage in the file-data reproducing mode of operation which uses the additional information, the drive control circuit 106 controls the servo circuit 103 so that the optical pickup 102 will sequentially access sectors on the optical disc 101 in an order starting from the head of the recording area 101D of the optical disc 101. The optical pickup 102 reads data from the sequentially-accessed sectors. The optical pickup 102 feeds the read data to the data processing circuit 104. The data processing circuit 104 subjects the read data to demodulation for reproduction and decoding for error correction to get processed data. The data processing circuit 104 feeds the processed data to the interface 105. The interface 105 sends the processed data to the interface 112 within the host 110. In this way, the optical disc drive 100 transmits the processed data to the host 110. The transmitted data is in the form of a sequence of sector data blocks. The optical disc drive 100 also transmits, to the host 110, the absolute physical addresses of sectors related to the transmitted sector data blocks. In the host 110, the interface 112 writes the incoming data into the memory 113. The data traveling from the interface 112 to the memory 113 is in the form of a sequence of sector data blocks accompanied with the absolute physical addresses of related sectors. The CPU 111 can refer to these sector addresses stored in the memory 113. The CPU 111 accesses additional information in each sector data block stored in the memory 113, and analyzes the accessed additional information. Through this operation step, the CPU 111 detects sector data blocks having additional information in which the first-sector identification information 13 is “1”, that is, sector data blocks coming from in-file first sectors. The CPU 111 transfers the file identification information 11 in the additional information in each of the detected sector data blocks to a table (a map) in the memory 113 while writing the absolute physical addresses of the related sectors into the table. When the additional information in the sector data block corresponding to the last one of the sectors has been analyzed by the CPU 111, file management data 400 is completed in the table in the memory 113.

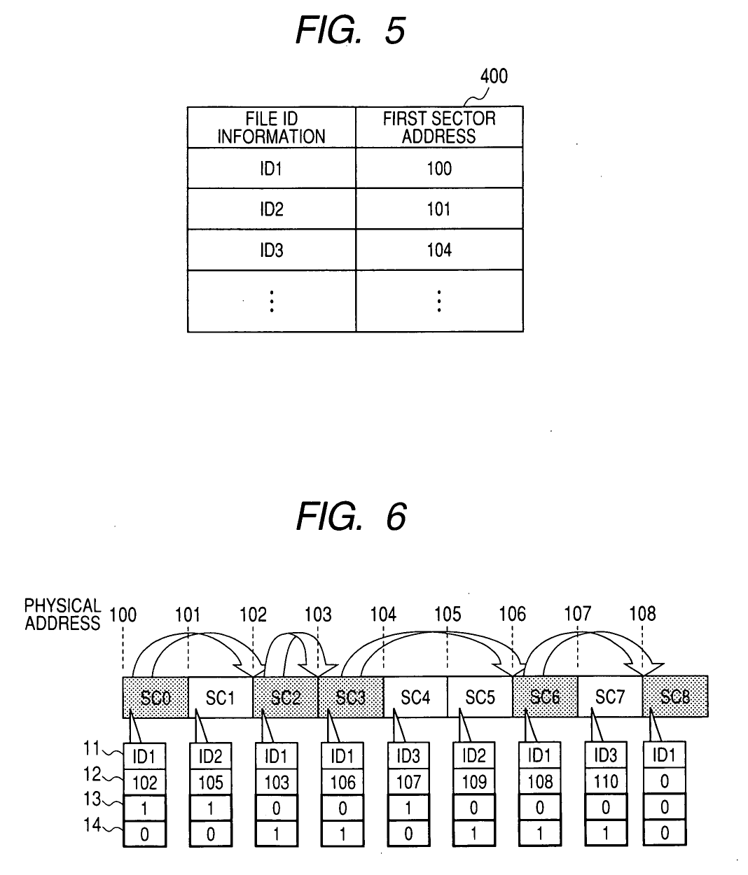

As shown in FIG. 5, the file management data 400 consists of pairs assigned to respective files and each having the file identification information (ID1, ID2, ID3, . . . ) and the absolute physical address of the first one of sectors assigned to the related file. The file management data 400 has relatively simple contents. Accordingly, the host 110 can make the file management data 400 at a high speed. Furthermore, the file management data 400 is relatively small in size. Thus, the memory 113 for storing the file management data 400 can be small in capacity.

During the former stage in the file-data reproducing mode of operation which uses the additional information, the optical pickup 102 may sequentially access sectors on the optical disc 101 in an order starting from an arbitrary place in the recording area 101D of the optical disc 101. In this case, the optical pickup 102 sequentially access sectors located between that place and the tail of the recording area 101D before sequentially accessing sectors located between the head of the recording area 101D and that place. Alternatively, the optical pickup 102 may sequentially access sectors located between that place and the head of the recording area 101D in the reverse direction before sequentially accessing sectors located between the tail of the recording area 101D and that place in the reverse direction.

In the case where sequential accesses are made with respect to sectors SC0, SC1, SC2, SC3, . . . each of which stores the file identification information 11, the next-sector address information 12, the first-sector identification information 13, and the effective-data identification information 14 in states shown by FIG. 3, the contents of the file management data 400 are those in FIG. 4.

During a later stage in the file-data reproducing mode of operation which uses the additional information, the CPU 111 searches the file management data 400 in the memory 113 for the file identification information 11 corresponding to a desired file. The CPU 111 may generate a signal representative of a list of files from the file management data 400. In this case, the CPU 111 feeds the generated signal to a display (not shown) within the host 110 and controls the display to present the list of files to a user on a GUI (Graphical User Interface) basis. The user selects one of the files as a desired file, and inputs information about the desired file into the host 110. The list of the files may be presented to the user in a way different from the above.

It is assumed that the file identification information 11 being ID1 corresponds to the desired file. The CPU 111 detects, among the pairs in the file management data 400, the pair having the file identification information 11 being ID1 (the file identification information 11 corresponding to the desired file). The CPU 111 controls the memory 113 to output the absolute physical address from the detected pair to the interface 112. In this case, the absolute physical address is that of the first one of sectors assigned to the desired file. The interface 112 sends the first absolute physical address to the interface 105 within the optical disc drive 100.

In the optical disc drive 100, the first absolute physical address propagates from the interface 105 to the drive control circuit 106. The drive control circuit 106 controls the servo circuit 103 in response to the first absolute physical address, thereby moving the optical pickup 102 to a position accorded with the first absolute physical address. Then, the optical pickup 102 reads data from the sector on the optical disc 101 at a position equal to the first absolute physical address. Accordingly, data is read from the first one of sectors assigned to the desired file. The optical pickup 102 feeds the read data to the data processing circuit 104. The data processing circuit 104 subjects the read data to demodulation for reproduction and decoding for error correction to get processed data. The data processing circuit 104 feeds the processed data to the interface 105. The interface 105 sends the processed data to the interface 112 within the host 110. The interface 112 writes the incoming data into the memory 113. The written data in the memory 113 is a sector data block coming from the first one of sectors assigned to the desired file. The CPU 111 accesses the memory 113 to check whether or not the next-sector address information 12 in the additional information in the present sector data block is “0”. When the next-sector address information 12 is not “0”, the CPU 111 controls the memory 113 to output the next-sector address information 12 from the present sector data block to the interface 112. In this case, the outputted next-sector address information 12 is the absolute physical address of the second one of sectors assigned to the desired file. The interface 112 sends the second absolute physical address to the interface 105 within the optical disc drive 100.

In the optical disc drive 100, the second absolute physical address propagates from the interface 105 to the drive control circuit 106. The drive control circuit 106 controls the servo circuit 103 in response to the second absolute physical address, thereby moving the optical pickup 102 to a position accorded with the second absolute physical address. Then, the optical pickup 102 reads data from the sector on the optical disc 101 at a position equal to the second absolute physical address. Accordingly, data is read from the second one of sectors assigned to the desired file. The optical pickup 102 feeds the read data to the data processing circuit 104. The data processing circuit 104 subjects the read data to demodulation for reproduction and decoding for error correction to get processed data. The data processing circuit 104 feeds the processed data to the interface 105. The interface 105 sends the processed data to the interface 112 within the host 110. The interface 112 writes the incoming data into the memory 113. The written data in the memory 113 is a sector data block coming from the second one of sectors assigned to the desired file. The CPU 111 accesses the memory 113 to check whether or not the next-sector address information 12 in the present sector data block is “0”. When the next-sector address information 12 is not “0”, the CPU 111 controls the memory 113 to output the next-sector address information 12 from the present sector data block to the interface 112. In this case, the outputted next-sector address information 12 is the absolute physical address of the third one of sectors assigned to the desired file. The interface 112 sends the third absolute physical address to the interface 105 within the optical disc drive 100.

In the optical disc drive 100, the third absolute physical address propagates from the interface 105 to the drive control circuit 106. The drive control circuit 106 controls the servo circuit 103 in response to the third absolute physical address, thereby moving the optical pickup 102 to a position accorded with the third absolute physical address. Then, the optical pickup 102 reads data from the sector on the optical disc 101 at a position equal to the third absolute physical address. Accordingly, data is read from the third one of sectors assigned to the desired file. The optical pickup 102 feeds the read data to the data processing circuit 104. The data processing circuit 104 subjects the read data to demodulation for reproduction and decoding for error correction to get processed data. The data processing circuit 104 feeds the processed data to the interface 105. The interface 105 sends the processed data to the interface 112 within the host 110. The interface 112 writes the incoming data into the memory 113. The written data in the memory 113 is a sector data block coming from the third one of sectors assigned to the desired file.

The above-indicated operation steps are iterated until the CPU 111 detects that the next-sector address information 12 in the sector data block which has just arrived is “0”. Therefore, data is read from the sectors assigned to the desired file on a sector-by-sector basis, and a sequence of sector data blocks coming from the respective desired-file sectors is inputted into the memory 113. The CPU 111 controls the memory 113 to serve as a demultiplexer for separating desired file data from the written data (the sequence of sector data blocks) and outputting the desired file data. The CPU 111 or another device receives the desired file data from the memory 113. In this way, the desired filed data is reproduced. When the next-sector address information 12 in the sector data block which has just arrived is “0”, the CPU 111 terminates the file-data reproducing mode of operation which uses the additional information.

As previously mentioned, in the event of failure in the reading of file system data from the optical disc 101, the apparatus of FIG. 1 reads the file identification information 11, the next-sector address information 12, and the first-sector identification information 13 from each of sectors on the optical disc 101. Then, the apparatus generates the file management data 400 in response to the file identification information 11, the next-sector address information 12, and the first-sector identification information 13. By referring to the file management data 400, the apparatus reproduces, from the optical disc 101, file data desired by the user. Thus, even in the case where file system data can not be read from the optical disc 101, the apparatus can reproduce desired file data.

The file-data additionally-recording mode of operation of the apparatus of FIG. 1 is as follows. It is assumed that one sector data block is required to be added to the tail of already-recorded file data corresponding to the file identification information 11 being ID1. In this case, the host 110 controls the optical disc drive 100 to reproduce a recording-area management table from an inner circumferential part of the optical disc 101. The CPU 111 in the host 110 refers to the reproduced recording-area management table and thereby selects, from all the sectors in the optical disc 101, one sector (the sector SC8 in FIG. 3) usable as a forthcoming last sector among sectors assigned to the file corresponding to the file identification information 11 being ID1. This sector selection may be implemented by referring to the file system data or the file management data 400. The recording-area management table may be contained in the file system data. Preferably, the selected sector is the first one among usable sectors at addresses later than the address of the last one of sectors assigned to the file corresponding to the file identification information 11 being ID1. In general, the selected sector is one which has not been used for data recording yet or one belonging to none of files. The CPU 111 provides 1-sector-corresponding stuffing data in the memory 113. The 1-sector-corresponding stuffing data is ineffective file data for one sector. The CPU 111 provides additional information in the memory 113 which is related to the 1-sector-corresponding stuffing data. The CPU 111 controls the memory 113 to output the stuffing data and the related additional information to the interface 112. The interface 112 sends the stuffing data and the related additional information to the interface 106 within the optical disc drive 100. The host 110 (the CPU 111) controls the optical disc drive 100 to address the stuffing data and the related additional information to the sector SC8 (see FIG. 3). Specifically, the additional information is directed to the additional-information recording area 10 in the sector SC8. As shown in FIG. 6, the CPU 111 sets the file identification information 11, the next-sector address information 12, the first-sector identification information 13, and the effective-data identification information 14 in the additional information to ID1, “0”, “0”, and “0” respectively.

In the optical disc drive 100, the stuffing data and the related additional information travels from the interface 105 to the optical pickup 102 through the data processing circuit 104. The optical pickup 102 records the stuffing data and the related additional information on the sector SC8 (see FIGS. 3 and 6) in the optical disc 101. Therefore, the sector SC8 has the ineffective file data. Furthermore, the sector SC8 has the additional information in which the file identification information 11, the next-sector address information 12, the first-sector identification information 13, and the effective-data identification information 14 are ID1, “0”, “0”, and “0” respectively. Thus, the sector SC8 becomes the new last one of sectors for the file corresponding to the file identification information 11 being ID1. It should be noted that as previously mentioned, ineffective file data such as stuffing data is recorded on the first and last sectors among sectors assigned to one file.

The CPU 111 detects the position of the last sector (the sector SC6) among sectors except the sector SC8, which are assigned to the file corresponding to the file identification information 11 being ID1, in a procedure similar to that in the file-data reproducing mode of operation which uses the file system data or the additional information. For example, the CPU 111 decides whether or not the first-sector identification information 13 and the effective-data identification information 14 in each of the sectors except the sector SC8 are “0”. The CPU 111 concludes the sector, in which the first-sector identification information 13 and the effective-data identification information 14 are “0”, to be the last sector (the sector SC6). In addition, the CPU 111 perceives that ineffective file data is recorded on the last sector since the effective-data identification information 14 therein is “0”. Then, the CPU 111 detects the position of the last sector.

The CPU 111 provides 1-sector-corresponding additional file data in the memory 113. The CPU 111 provides additional information in the memory 113 which is related to the 1-sector-corresponding additional file data. The CPU 111 controls the memory 113 to output the additional file data and the related additional information to the interface 112. The interface 112 sends the additional file data and the related additional information to the interface 106 within the optical disc drive 100. The host 110 (the CPU 111) controls the optical disc drive 100 to address the additional file data and the related additional information to the sector SC6 (the above-indicated detected last sector). Specifically, the additional information is directed to the additional-information recording area 10 in the sector SC6. As shown in FIG. 6, the CPU 111 sets the file identification information 11, the next-sector address information 12, the first-sector identification information 13, and the effective-data identification information 14 in the additional information to ID1, “108”, “0”, and “1” respectively. The next-sector address information 12 being “108” is the absolute physical address of the sector SC8 (see FIGS. 3 and 6).

In the optical disc drive 100, the additional file data and the related additional information travels from the interface 105 to the optical pickup 102 through the data processing circuit 104. The optical pickup 102 writes or records the additional file data and the related additional information over the old file data and the old additional information in the sector SC6 (see FIGS. 3 and 6) in the optical disc 101. Therefore, the next-sector address information 12 in the additional information in the sector SC6 is changed from “0” to “108” indicating the absolute physical address of the sector SC8 (see FIGS. 3 and 6). The effective-data identification information 14 in the additional information in the sector SC6 is changed from “0” to “1” indicating the presence of an effective file data piece therein. Thus, among sectors assigned to the expanded file corresponding to the file identification information 11 being ID1, the sector SC6 becomes the sector immediately preceding the in-file last sector SC8 and loaded with the effective file data. In this way, the in-file last sector shifts from the sector SC6 to the sector SC8.

As previously mentioned, the last sector (the sector SC6) among sectors assigned to one file is detected when the first-sector identification information 13 and the effective-data identification information 14 therein are “0”. The last sector is recognized as a sector loaded with ineffective file data since the effective-data identification information 14 therein is “0”. Additional file data is recorded over the ineffective file data in the last sector while the new next-sector address information 12 being “108” is recorded over the old next-sector address information 12 therein. The usable sector (the sector SC8) following the last sector is set as a new in-file last sector. In this way, the recording of additional file data on the optical disc 101 is implemented. On the other hand, the recorded information and data in each of the other sectors assigned to the file remain unchanged. Accordingly, it is unnecessary to perform the revision of the recorded information and data in each of the other sectors assigned to the file which would require the recalculation of an error correction code and might result in a decrease in the reliability of the recorded file data.

As previously mentioned, each of sectors assigned to one file is loaded with the effective-data identification information 14. By referring to the effective-data identification information 14, a decision can easily be made as to whether a file data piece recorded on the related sector is effective or ineffective. By referring to the effective-data identification information 14 in each of sectors, a sector loaded with an ineffective file data piece can easily be detected in the case where additional file data is required to be recorded on the optical disc 101. Therefore, it is possible to safely and easily implement the recording of additional file data on the optical disc 101 on a sector-by-sector basis.

As previously mentioned, ineffective file data such as stuffing data is recorded on the first and last sectors among sectors assigned to one file. Therefore, the first and last sectors can easily be discriminated from other sectors (sectors loaded with effective file data). By referring to the file identification information 11, the next-sector address information 12, the first-sector identification information 13, and the effective-data identification information 14 in the additional information in each of sectors, the last sector among sectors assigned to one file can easily be detected in the case where additional file data is required to be recorded on the optical disc 101.

The intermediate-file-data deleting mode of operation of the apparatus of FIG. 1 is as follows. It is assumed that file data pieces are required to be deleted from the sectors SC2 and SC3 when the sectors in the optical disc 101 are in states of FIG. 6. The sectors SC2 and SC3 are intermediate ones of sectors assigned to the file corresponding to the file identification information 11 being ID1. The CPU 111 finds the sectors SC2, SC3, and SC6 in a procedure similar to that in the file-data reproducing mode of operation which uses the file system data or the additional information. The host 110 controls the optical disc drive 100 to read the additional information from each of the sectors SC2 and SC3. The read additional information is sent from the optical disc drive 100 to the host 110. In the host 110, the read additional information travels from the interface 112 to the memory 113. The CPU 111 controls the memory 113 to store the read additional information.

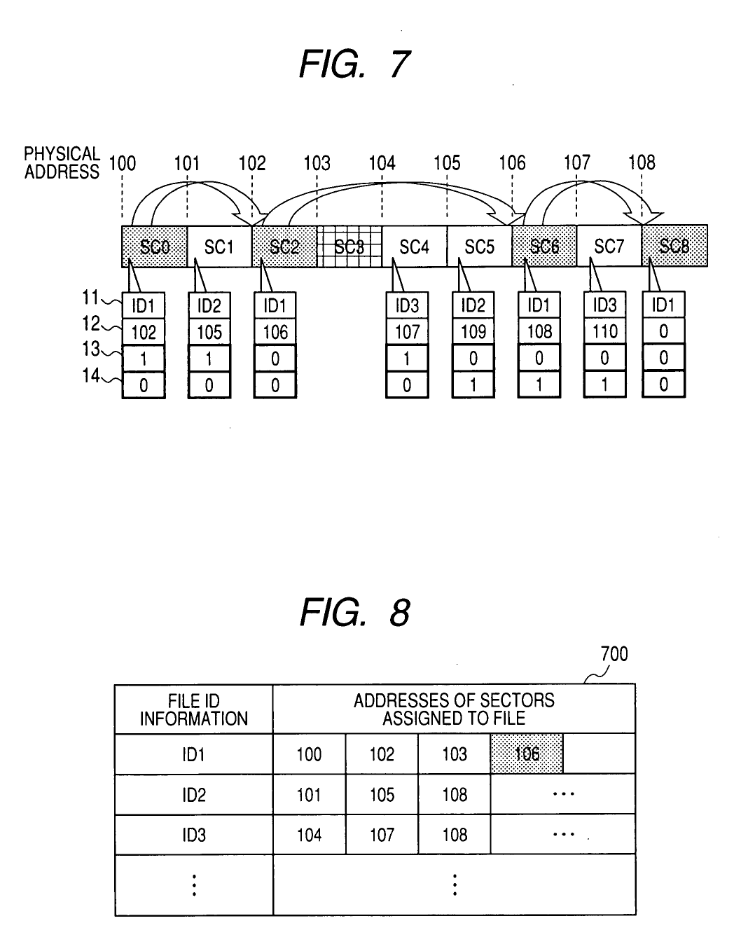

The CPU 111 provides 1-sector-corresponding stuffing data in the memory 113. The 1-sector-corresponding stuffing data is ineffective file data for one sector. The CPU 111 provides additional information in the memory 113 which is related to the 1-sector-corresponding stuffing data. The CPU 111 controls the memory 113 to output the stuffing data and the related additional information to the interface 112. The interface 112 sends the stuffing data and the related additional information to the interface 106 within the optical disc drive 100. The host 110 (the CPU 111) controls the optical disc drive 100 to address the stuffing data and the related additional information to the sector SC2. Specifically, the additional information is directed to the additional-information recording area 10 in the sector SC2. As shown in FIG. 7, the CPU 111 sets the file identification information 11, the next-sector address information 12, the first-sector identification information 13, and the effective-data identification information 14 in the additional information to ID1, “106”, “0”, and “0” respectively. The next-sector address information 12 being “106” is the absolute physical address of the sector SC6 (see FIGS. 6 and 7). The CPU 111 imports the next-sector address information 12 being “106” from the additional information in the sector SC3 which is stored in the memory 113.

In the optical disc drive 100, the stuffing data and the related additional information travels from the interface 105 to the optical pickup 102 through the data processing circuit 104. The optical pickup 102 writes or records the stuffing data and the related additional information over the old file data and the old additional information in the sector SC2 (see FIGS. 6 and 7) in the optical disc 101. Therefore, the effective file data in the sector SC2 is replaced by the ineffective file data. Furthermore, the additional information in the sector SC2 is updated so that the file identification information 11, the next-sector address information 12, the first-sector identification information 13, and the effective-data identification information 14 therein are ID1, “106”, “0”, and “0” respectively. Thus, the next-sector address information 12 in the sector SC2 is changed from “103” to “106” indicating the absolute physical address of the sector SC6 while the effective-data identification information 14 therein is changed from “1” to “0” indicating the presence of ineffective file data therein.

Preferably, the host 110 controls the optical disc drive 100 so that the file data and the additional information in the sector SC3 will remain unchanged. Since the next-sector address information 12 in the sector SC2 is changed to “106” indicating the absolute physical address of the sector SC6, the sector SC2 is followed by the sector SC6 rather than the sector SC3 in the sequence of sectors assigned to the file corresponding to the file identification information 11 being ID1. As a result, the sector SC3 will not be referred to by the additional information in another sector, and hence can be handled as a usable sector for data recording. Thus, for the apparatus of FIG. 1, the sector SC3 looks like a sector from which the effective file data has been erased. It should be noted that the file data and the additional information may be erased from the sector SC3, or may be replaced by other signals on an overwrite basis.

As previously mentioned, the additional information in the sector SC2 is updated or revised while the effective file data is erased therefrom. On the other hand, the additional information and data in each of other sectors assigned to the file corresponding to the file identification information 11 being ID1 remain unchanged. Accordingly, it is unnecessary to perform the revision of the additional information in each of the other sectors which would require the recalculation of an error correction code and might result in a decrease in the reliability of recorded file data.

In summary, the apparatus of FIG. 1 records file data on the optical disc 101 on a sector-by-sector basis. During the recording of the file data on the optical disc 101, the apparatus also records additional information in each of accessed sectors on the optical disc 101. The recorded additional information relates to the recorded file data. The recorded additional information includes the file identification information 11, the next-sector address information 12, the first-sector identification information 13, and the effective-data identification information 14. The apparatus records file system data on a portion of the optical disc 101 which extends in the vicinity or immediate vicinity of the lead-in area 101B or the lead-out area 101C. The file system data is designed for the management of the recorded file data. To reproduce desired file data from the optical disc 101, the apparatus tries to read file system data from the optical disc 101. In the event that the file system data is not successfully read, the apparatus refers to the additional information in each sector on the optical disc 101 and thereby recognizes sectors assigned to the desired file data. The apparatus reproduces the desired file data from the recognized sectors.

When additional file data is required to be recorded on the optical disc 101, the apparatus of FIG. 1 detects the last sector among sectors assigned to a related file by referring to the effective-data identification information 14 therein. Specifically, the apparatus concludes the sector, in which the effective-data identification information 14 is “0” to be the last sector. The apparatus perceives that the last sector has ineffective file data since the effective-data identification information 14 therein is “0”. The apparatus records the additional file data over the ineffective file data in the last sector while changing the new next-sector address information 12 therein. It is unnecessary to perform the revision of the recorded information and data in each of the other sectors assigned to the file which would require the recalculation of an error correction code and might result in a decrease in the reliability of the recorded file data.

When an intermediate portion is required to be deleted from recorded file data on the optical disc 101, the apparatus of FIG. 1 changes the new next-sector address information 12 in an intermediate sector among sectors assigned to the file data. It is unnecessary to perform the revision of the additional information in each of the other sectors which would require the recalculation of an error correction code and might result in a decrease in the reliability of recorded file data.

The effective-data identification information 14 in each sector on the optical disc 101 which is “0” indicates that a file data piece in the sector is ineffective. Accordingly, by referring to the effective-data identification information 14 in each sector, it is possible to easily decide whether or not a file data piece in the sector is ineffective. The ineffective file data piece can be discarded. It is possible to efficiently construct file data recorded on the optical disc 101. The effective-data identification information 14 can be utilized for a random access to recorded file data in the optical disc 101 on a sector-by-sector basis. It is possible to efficiently use the memory 113.

When file data pieces are required to be deleted from successive intermediate sectors among sectors assigned to a file, only the additional information in the first sector in the intermediate sectors is updated and the additional information in the other sectors remains unchanged. Accordingly, it is unnecessary to perform the revision of the additional information in each of the other sectors which would require the recalculation of an error correction code and might result in a decrease in the reliability of recorded file data.

### Second Embodiment

A second embodiment of this invention is similar to the first embodiment thereof except for design changes indicated hereafter. According to the second embodiment of this invention, file management data 700 replaces the file management data 400 (see FIG. 5).

As shown in FIG. 8, the file management data 700 consists of sets assigned to respective files and each having the file identification information (ID1, ID2, ID3, . . . ) and the absolute physical addresses of sectors assigned to the related file.

During a former stage in the file-data reproducing mode of operation which uses the additional information, the drive control circuit 106 controls the servo circuit 103 so that the optical pickup 102 will sequentially access sectors on the optical disc 101 in an order starting from the head of the recording area 101D of the optical disc 101. The optical pickup 102 reads data from the sequentially-accessed sectors. The optical pickup 102 feeds the read data to the data processing circuit 104. The data processing circuit 104 subjects the read data to demodulation for reproduction and decoding for error correction to get processed data. The data processing circuit 104 feeds the processed data to the interface 105. The interface 105 sends the processed data to the interface 112 within the host 110. In this way, the optical disc drive 100 transmits the processed data to the host 110. The transmitted data is in the form of a sequence of sector data blocks. The optical disc drive 100 also transmits, to the host 110, the absolute physical addresses of sectors related to the transmitted sector data blocks. In the host 110, the interface 112 writes the incoming data into the memory 113. The data traveling from the interface 112 to the memory 113 is in the form of a sequence of sector data blocks accompanied with the absolute physical addresses of related sectors. The CPU 111 can refer to these sector addresses stored in the memory 113. The CPU 111 accesses additional information in each sector data block written in the memory 113, and analyzes the accessed additional information. Through this operation step, the CPU 111 detects sector data blocks having additional information in which the first-sector identification information 13 is “1”, that is, sector data blocks coming from in-file first sectors. The CPU 111 gets the absolute physical addresses of the sectors from which the detected sector data blocks come.

Regarding each of the detected sector data blocks coming from the in-file first sectors, the CPU 111 identifies a sector immediately following the in-file first sector in response to the next-sector address information 12 in the detected sector data block. Thus, the CPU 111 detects the in-file second sector and gets the absolute physical address thereof. The CPU 111 decides whether or not the next-sector address information 12 in the sector data block coming from the in-file second sector is “0”, that is, whether or not the in-file second sector is the last one among sectors assigned to the present file. When the next-sector address information 12 is not “0”, the CPU 111 identifies a sector immediately following the in-file second sector in response to the next-sector address information 12 in the sector data block coming from the in-file second sector. The CPU 111 iterates the above operation steps until meeting the next-sector address information 12 being “0”. As a result, the CPU 111 gets the absolute physical addresses of all the sectors assigned to the present file. On the other hand, when the next-sector address information 12 is “0”, the CPU 111 transfers the file identification information 11 in the additional information in the detected sector data block coming from the in-file first sector to a table (a map) in the memory 113 and sequentially places the absolute physical addresses of all the sectors assigned to the present file in the table.

When the additional information in the sector data block coming from the last one of the sectors on the optical disc 101 has been analyzed by the CPU 111, file management data 700 is completed in the table in the memory 113.

As shown in FIG. 8, the file management data 700 has the absolute physical addresses of sectors assigned to each file which are sequentially arranged with respect to the structure of the file. Thus, it is possible to directly detect the structure of each file from the file management data 700. Accordingly, the host 110 can control the optical disc drive 100 and access file data in the optical disc 101 at a high speed by referring to the file management data 700. Furthermore, the host 110 can access file data pieces in arbitrarily-selected sectors (for example, the sectors SC2 and SC5 in FIGS. 3, 6, and 7) on a random basis by referring to their absolute physical addresses in the file management data 700.

The file system data is recorded on the optical disc 101. The host 110 can utilize the file management data 700 instead of the file system data to detect sectors assigned to a desired file.

During a later stage in the file-data reproducing mode of operation which uses the additional information, the CPU 111 searches the file management data 700 in the memory 113 for the file identification information 11 corresponding to a desired file. The CPU 111 may generate a signal representative of a list of files from the file management data 700. In this case, the CPU 111 feeds the generated signal to the display (not shown) within the host 110 and controls the display to present the list of files to a user on a GUI (Graphical User Interface) basis. The user selects one of the files as a desired file, and inputs information about the desired file into the host 110. The list of the files may be presented to the user in a way different from the above.

It is assumed that the file identification information 11 being ID1 corresponds to the desired file. The CPU 111 accesses, among the sets in the file management data 700, the set having the file identification information 11 being ID1 (the file identification information 11 corresponding to the desired file) and the absolute physical addresses of sectors assigned to the desired file. The CPU 111 controls the memory 113 to output “100”, that is, the absolute physical address of the first one of the desired-file sectors from the accessed set in the file management data 700 to the interface 112. The interface 112 sends the first absolute physical address to the interface 105 within the optical disc drive 100.

In the optical disc drive 100, the first absolute physical address propagates from the interface 105 to the drive control circuit 106. The drive control circuit 106 controls the servo circuit 103 in response to the first absolute physical address, thereby moving the optical pickup 102 to a position accorded with the first absolute physical address. Then, the optical pickup 102 reads data from the sector on the optical disc 101 at a position equal to the first absolute physical address. Accordingly, data is read from the first one of sectors assigned to the desired file. The optical pickup 102 feeds the read data to the data processing circuit 104. The data processing circuit 104 subjects the read data to demodulation for reproduction and decoding for error correction to get processed data. The data processing circuit 104 feeds the processed data to the interface 105. The interface 105 sends the processed data to the interface 112 within the host 110. The interface 112 writes the incoming data into the memory 113. The written data in the memory 113 is a sector data block coming from the first one of sectors assigned to the desired file.

Similarly, the CPU 111 controls the memory 113 to sequentially output the absolute physical addresses of the second and later ones of the desired-file sectors from the accessed set in the file management data 700 to the interface 112. The interface 112 sequentially sends the second and later absolute physical addresses to the interface 105 within the optical disc drive 100.

In the optical disc drive 100, the second and later absolute physical addresses sequentially propagate from the interface 105 to the drive control circuit 106. The drive control circuit 106 controls the servo circuit 103 in response to each of the second and later absolute physical addresses, thereby moving the optical pickup 102 to a position accorded with the present absolute physical address. Then, the optical pickup 102 reads data from the sector on the optical disc 101 at a position equal to the present absolute physical address. Accordingly, data is read from each of the second and later ones of sectors assigned to the desired file. The optical pickup 102 feeds the read data to the data processing circuit 104. The data processing circuit 104 subjects the read data to demodulation for reproduction and decoding for error correction to get processed data. The data processing circuit 104 feeds the processed data to the interface 105. The interface 105 sends the processed data to the interface 112 within the host 110. The interface 112 writes the incoming data into the memory 113. The written data in the memory 113 is a sequence of sector data blocks coming from the second and later ones of sectors assigned to the desired file. In this way, a sequence of sector data blocks coming from the respective desired-file sectors is inputted and written into the memory 113.

The CPU 111 controls the memory 113 to serve as a demultiplexer for separating desired file data from the written data (the sequence of sector data blocks) and outputting the desired file data. The CPU 111 or another device receives the desired file data from the memory 113. In this way, the desired filed data is reproduced. During that time, the CPU 111 accesses the effective-data identification information 14 in each of the sector data blocks. The CPU 111 decides whether or not the accessed effective-data identification information 14 is “0”. The CPU 111 discards a file data piece (an ineffective file data piece or a stuffing data piece) in each sector data block having the accessed effective-data identification information 14 being “0”. The data discard suppresses an increase in the required capacity of the memory 113.

As understood from the above description, the apparatus of FIG. 1 can read file data corresponding to each of desired files from the optical disc 101 in accordance with the file management data 700.

As previously mentioned, the file management data 700 has the absolute physical addresses of sectors assigned to each file which are sequentially arranged with respect to the structure of the file. Thus, it is possible to directly detect the structure of each file from the file management data 700. Accordingly, the host 110 can control the optical disc drive 100 and access file data in the optical disc 101 at a high speed by referring to the file management data 700. Furthermore, the host 110 can access file data pieces in arbitrarily-selected sectors on a random basis by referring to their absolute physical addresses in the file management data 700.

### Third Embodiment

A third embodiment of this invention is similar to the first or second embodiment thereof except that the additional information is recorded in units each corresponding to a plurality of sectors.

### Fourth Embodiment

A fourth embodiment of this invention is similar to the first or second embodiment thereof except that the additional information is recorded in units independent of sectors.

### Fifth Embodiment

According to a fifth embodiment of this invention, the apparatus of FIG. 1 is modified into an apparatus for recording data on an optical disc which does not have a data reproducing function.

### Sixth Embodiment

According to a sixth embodiment of this invention, the apparatus of FIG. 1 is modified into an apparatus for reproducing data from an optical disc which does not have a data recording function.

What is claimed is:

1. A method of recording file data on a recording medium, comprising the steps of:
generating additional information for each of unit recording blocks in the recording medium;
recording the generated additional information on a first area in the corresponding unit recording block; and
recording a piece of the file data on a second area in each of the unit recording blocks, the second area differing from the first area;
wherein the generated additional information for each of the unit recording blocks includes 1) file identification information for identifying the file data, 2) next-sector address information indicating an address of a unit recording block which follows the present unit recording block, and 3) first-sector identification information indicating whether or not the present unit recording block is first one of the unit recording blocks assigned to the file data.

2. A method as recited in claim 1, further comprising the step of recording file system data for management of the file data on a system data recording area in the recording medium, the system data recording area being unoccupied by the recorded additional information and the recorded file data.

3. A method as recited in claim 1, wherein the generated additional information for each of the unit recording blocks further includes effective-data identification information indicating whether a piece of the file data which is recorded on the present unit recording block is effective or ineffective.

4. An apparatus for recording file data on a recording medium, comprising:
means for generating additional information for each of unit recording blocks in the recording medium;
means for recording the generated additional information on a first area in the corresponding unit recording block; and
means for recording a piece of the file data on a second area in each of the unit recording blocks, the second area differing from the first area;
wherein the generated additional information for each of the unit recording blocks includes 1) file identification information for identifying the file data, 2) next-sector address information indicating an address of a unit recording block which follows the present unit recording block, and 3) first-sector identification information indicating whether or not the present unit recording block is first one of the unit recording blocks assigned to the file data.

5. An apparatus as recited in claim 4, further comprising means for recording file system data for management of the file data on a system data recording area in the recording medium, the system data recording area being unoccupied by the recorded additional information and the recorded file data.

6. An apparatus as recited in claim 4, wherein the generated additional information for each of the unit recording blocks further includes effective-data identification information indicating whether a piece of the file data which is recorded on the present unit recording block is effective or ineffective.

7. A recording medium comprising unit recording blocks each having a first area storing additional information and a second area storing a piece of file data, the first area and the second area differing from each other, wherein the additional information stored in the first area in each of the unit recording blocks includes 1) file identification information for identifying the file data, 2) next-sector address information indicating an address of a unit recording block which follows the present unit recording block, and 3) first-sector identification information indicating whether or not the present unit recording block is first one of the unit recording blocks assigned to the file data.

8. A recording medium as recited in claim 7, further comprising a system data recording area storing file system data for management of the file data, the system data recording area being unoccupied by the recorded additional information and the recorded file data.

9. A recording medium as recited in claim 7, wherein the additional information stored in the first area in each of the unit recording blocks further includes effective-data identification information indicating whether a piece of the file data which is recorded on the present unit recording block is effective or ineffective.

10. A method of reproducing file data from a recording medium comprising unit recording blocks each having a first area storing additional information and a second area storing a piece of file data, the first area and the second area differing from each other, wherein the additional information stored in the first area in each of the unit recording blocks includes 1) file identification information for identifying the file data, 2) next-sector address information indicating an address of a unit recording block which follows the present unit recording block, and 3) first-sector identification information indicating whether or not the present unit recording block is first one of the unit recording blocks assigned to the file data, the recording medium further comprising a system data recording area storing file system data for management of the file data, the system data recording area being unoccupied by the recorded additional information and the recorded file data, the method comprising the steps of:
reading the file system data from the recording medium;
deciding whether or not the reading of the file system data from the recording medium is successful;
reading the file identification information, the next-sector address information, and the first-sector identification information from each of the unit recording blocks in the recording medium when it is decided that the reading of the file system data from the recording medium is not successful;
generating file management data from the read file identification information, the read next-sector address information, and the read first-sector identification information; and
reading the file data from the recording medium in response to the generated file management data.

11. An apparatus for reproducing file data from a recording medium comprising unit recording blocks each having a first area storing additional information and a second area storing a piece of file data, the first area and the second area differing from each other, wherein the additional information stored in the first area in each of the unit recording blocks includes 1) file identification information for identifying the file data, 2) next-sector address information indicating an address of a unit recording block which follows the present unit recording block, and 3) first-sector identification information indicating whether or not the present unit recording block is first one of the unit recording blocks assigned to the file data, the recording medium further comprising a system data recording area storing file system data for management of the file data, the system data recording area being unoccupied by the recorded additional information and the recorded file data, the apparatus comprising:
means for reading the file system data from the recording medium;
means for deciding whether or not the reading of the file system data from the recording medium is successful;
means for reading the file identification information, the next-sector address information, and the first-sector identification information from each of the unit recording blocks in the recording medium when it is decided that the reading of the file system data from the recording medium is not successful;
means for generating file management data from the read file identification information, the read next-sector address information, and the read first-sector identification information; and
means for reading the file data from the recording medium in response to the generated file management data.
